(19) United States
(12) Patent Application Publication
(10) Pub. No.: US 2015/0318693 A1
(43) Pub. Date: Nov. 5, 2015

(54) Coil with Shunt Impedance for Arc Suppression using an Alternating Current Power Source or a Direct Current Power Source

(71) Applicant: John Richard Archer, Spencer, IN (US)

(72) Inventor: John Richard Archer, Spencer, IN (US)

(21) Appl. No.: 14/701,500

(22) Filed: Apr. 30, 2015

Related U.S. Application Data
(60) Provisional application No. 61/986,315, filed on Apr. 30, 2014.

(51) Int. Cl. H02H 9/08

(52) U.S. Cl. CPC H02H 9/08

(57) ABSTRACT

A device used for preventing arcs in an electric circuit contains an output source terminal, an input load terminal, a suppressor coil, and a shunt circuit. The output source circuit can be either an alternating power source or a direct current power source. The suppressor coil is electrically connected in between the output power source and the input load terminal. In order to prevent arc formation and shape the current passing through the suppressor coil, the shunt circuit is electrically connected in parallel to the suppressor coil. The shunt circuit includes at least one resistor, at least one inductor, and at least on capacitor. The suppressor coil can be either a permeable coil or an air core coil. The design of the device allows a circuit breaker to be used in series. Moreover, the device does not require resetting after use.

The current application claims a priority to the U.S. Provisional Patent application Ser. No. 61/986,315 filed on Apr. 30, 2014.

### FIELD OF THE INVENTION

The present invention relates generally to a circuit design that can prevent or reduce the possibility of electrical arcing which can occur through a rapid reduction of voltage across an electrical circuit.

### BACKGROUND OF THE INVENTION

An electric arc is a visible plasma discharge between two electrodes that is caused by electrical current ionizing gasses in the air. Electric arcing can lead to local ignition of vapors or flammable items. Therefore, it is clearly evident that a method for effectively suppressing an electric arc is essential.

Arc suppression can be done through various methods. Metal film deposition and sputtering and arc flash protection equipment are some of the most renowned arc suppression methods. Even though these arc suppressing techniques have a series of advantages, certain disadvantages are also seen. For instance, most arc suppression techniques require a considerable financial investment. Therefore, the additional investment has resulted in using these arc suppression techniques sparingly. Another disadvantage of arc suppression techniques is the inability to be used with every circuit. Certain circuit configurations utilized for arc suppression require current and voltage requirements. As an example, most arc suppression circuits function with only an alternating current power source or with only a direct current power source. Therefore, the number of circuits the arc suppression circuit can be used with is limited.

A series pass transistor can also be used to prevent arc formation. Similar to the present invention, the series pass transistor can reduce or remove voltage from the input load terminal. However, during normal operation the series pass transistor requires a large heat sink such that extra time is required to respond when a fault occurs. In addition to the extra time required to respond, the series pass transistor requires additional components for functioning. When attempting to prevent arc formation in a confined space, such as an aircraft, the additional storage space is significantly disadvantageous.

The objective of the present invention is to address the aforementioned issues. More specifically, the present invention is intended to prevent damage to electrical wiring and associated components due to an event that could produce arcing at the load end, or along a power transmission line. In doing so, an inductance with a parallel shunt impedance is added to the circuit in between the electrical load and the power source. Moreover, the present invention can be used with both an alternating current source and a direct current power source.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an illustration of the circuit diagram of the present invention.

FIG. 2 is a circuit diagram of the transmission line.

FIG. 3 is a graph illustrating the ionization time and the arcing time when the present invention is used.

FIG. 4 is a graph illustrating the short circuit in a circuit without the present invention.

FIG. 5 is a graph illustrating the line current in the circuit when the present invention is included.

FIG. 6 a combined graph illustrating the results obtained by utilizing the present invention.

FIG. 7 is a graph illustrating the constant voltage obtained across the input load terminal with the present invention.

FIG. 8 is a graph illustrating the energy flow across the input load terminal.

FIG. 9 is a graph illustrating the short circuit release.

FIG. 10 is a graph illustrating the line current when the circuit breaker is not activated.

FIG. 11 is a graph illustrating the open circuit line voltage.

FIG. 12 is a graph illustrating the open circuit input load terminal voltage release.

FIG. 13 is a graph illustrating the current of a strobe light when the present invention is integrated into the strobe light.

FIG. 14 is a circuit diagram illustrating the at least one resistor, the at least one inductor, and the at least on capacitor within the shunt circuit.

### DETAIL DESCRIPTIONS OF THE INVENTION

All illustrations of the drawings are for the purpose of describing selected versions of the present invention and are not intended to limit the scope of the present invention.

The present invention introduces an apparatus that can prevent arc formation in an alternating current (AC) power source or a direct current (DC) power source. In doing so, the present invention removes power from the fault location as soon as the necessary requirements for arc formation occurs, such that the chance of fire or kapton carbon tube formation is lessened. A suppressor coil and a parallel shunt circuit are added to a circuit in between the power source and the electric load to remove power from the electric load within a short period of time. The preferred embodiment of the present invention is intended to be used in aircraft circuit. However, the present invention can also be used in any other circuit where an electric arc can occur.

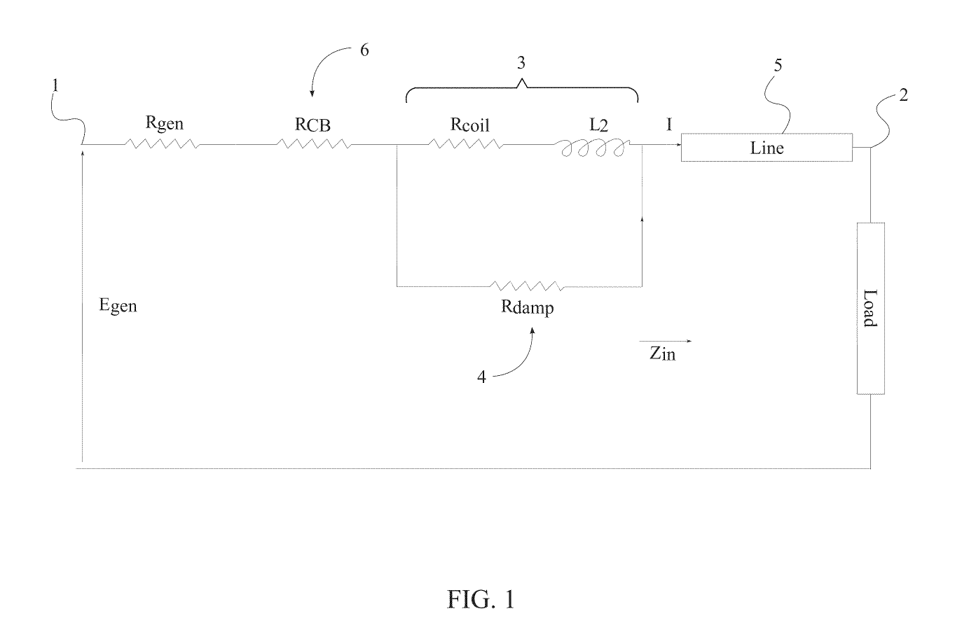

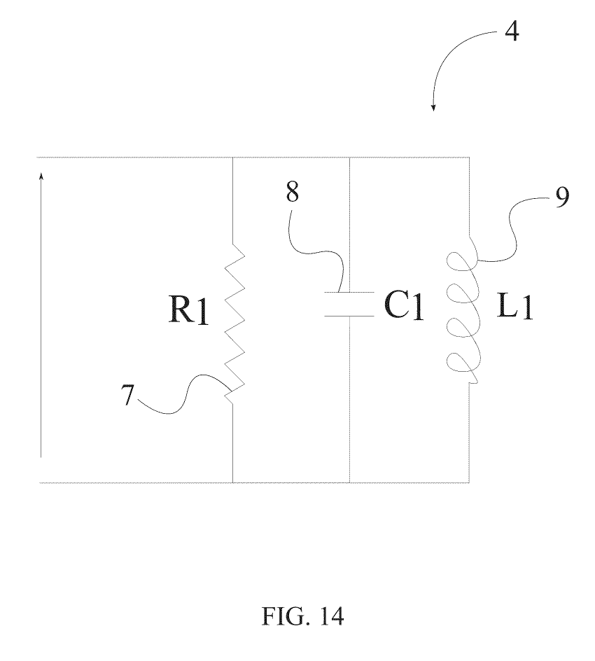

The present invention comprises an output source terminal 1, an input load terminal 2, a suppressor coil 3, and a shunt circuit 4. The suppressor coil 3 can be either an air core coil or a permeable coil. In order to remove the power from the output source terminal 1 and prevent arc formation, the suppressor coil 3 is electrically connected in series between the output source terminal 1 and the input load terminal 2. Therefore, the vector sum of the circuit voltages across the suppressor coil 3, the shunt circuit 4, and the input load terminal 2 is equal to the voltage at the output source terminal 1. The suppressor coil 3 is configured to generate electrical inductance and to be electrically resistive. The inductance and the resistance of the suppressor coil 3 are electrically connected to each other in series. Similar to the suppressor coil 3, the shunt circuit 4 is also electrically connected in series between the output source terminal 1 and the input load terminal 2. However, for the shunt circuit 4 to divert current away from the suppressor coil 3, the suppressor coil 3 and the shunt circuit 4 are connected in parallel to each other such that the shunt circuit 4 creates a low impedance path for the current to flow through. Any component connected in parallel to the suppressor coil 3 is represented by the shunt circuit 4. Diverting current away helps reduce the suppressor coil 3 ampere-turn product reduction as line current increases. More specifically, the suppressor coil 3 and the shunt circuit 4 act as a temporary virtual series control element with high efficiency preventing local ignition of vapors or flammable items. Moreover, the shunt circuit 4 helps in making the suppressor coil 3 small in size with a small core air gap. In general, the shunt circuit 4 controls the suppressor coil 3 current, peak voltage, amplitude of the residual fault current, and the load fault voltage. Moreover, the shunt circuit 4 holds the suppressor coil 3 current and voltage to safe and steady values while reducing the line input current and minimizing the voltage exiting the suppressor coil 3. As illustrated in FIG. 14, the shunt circuit 4 comprises at least one resistor 7, at least one capacitor 8, and at least one inductor 9. In other words, the shunt circuit 4 can be a combination of any number of resistors, inductors, or capacitors. The combination of the shunt circuit 4 helps reduce the physical size of the suppressor coil 3. As a result, the suppressor coil 3 has low winding power loss, lower inductance, and a reduced voltage drop. The configuration of the shunt circuit 4 can differ according to the circuit the present invention is used in. In reference to FIG. 1, the shunt circuit 4 is represented by R_{damp}. The suppressor coil 3 resistance is represented by R_{coil} and the suppressor coil 3 inductance is represented by L₂. As seen in FIG. 1, the suppressor coil 3 is in parallel to the shunt circuit 4.

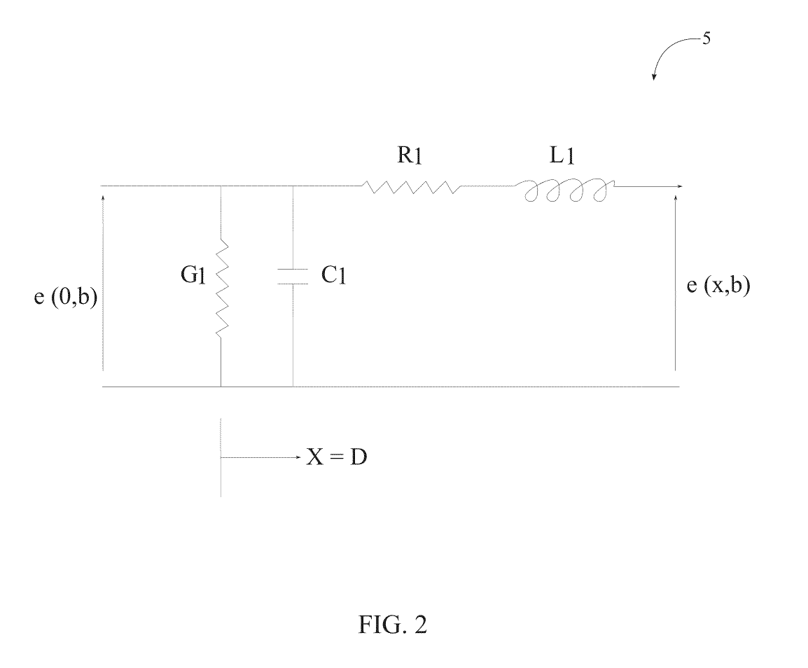

The present invention further comprises an at least one transmission line 5 that extends from the suppressor coil 3 to the input load terminal 2. More specifically, the suppressor coil 3 is electrically connected in series with the input load terminal 2 through the transmission line 5. Since the shunt circuit 4 is electrically connected between the output source terminal 1 and the input load terminal 2, the shunt circuit 4 is electrically connected in series with the input load terminal 2 through the transmission line 5. The preferred embodiment of the present invention is intended to be used on an aircraft circuit. Therefore, a portion of the transmission line 5 can be a portion of the aircraft body. The transmission line 5 utilized in the present invention is represented in FIG. 2.

The present invention is electrically integrated to a circuit breaker 6. The circuit breaker 6 is electrically connected in series between the output source terminal 1 and the input load terminal 2. Therefore, a resistance of the circuit breaker 6, R_{CB}, is also connected in series between the output source terminal 1 and the input load terminal 2. As discussed earlier, when the shunt circuit 4 diverts a portion of the current from the suppressor coil 3, the current through the circuit breaker 6 reduces to a value less than the normal short circuit value. More specifically, the suppressor coil 3 and the shunt circuit 4 holds the fault voltage of the input load terminal 2 below a specific voltage which leads to arc formation. The voltage is maintained until the arc formation conditions disperse or the circuit breaker 6 is activated. The series connection of the circuit between the output source terminal 1 and the input load terminal 2 allows the circuit breaker 6 to trip if the fault at the input load terminal 2 continues beyond the initial quenching time. In other words, the suppressor coil 3 and the shunt circuit 4 do not interfere with the normal operation of the circuit breaker 6. The circuit breaker 6 current is set from the circuit breaker 6 trip time, power line parameters, and the power source capability. Since the shunt circuit 4 in parallel to the suppressor coil 3 diverts current away from the suppressor coil 3, and the circuit breaker 6 trips after the initial quenching time, the need to reset the shunt circuit 4 or the suppressor coil 3 in parallel to the shunt circuit 4 is eliminated. Even though the preferred embodiment of the present invention is electrically connected to the circuit breaker 6, the present invention can also function without the circuit breaker 6. Furthermore, in an alternative embodiment of the present invention, the circuit breaker 6 can be integrated as a component of the present invention.

The effective design of the present invention can prevent arc formation when the output source terminal 1 is for an alternating current (AC) power source and also when the output source terminal 1 is for a direct current (DC) power source. Therefore, the present invention can be used in a wide range of applications. However, the output source terminal 1 needs to exceed the threshold voltage required for the arc to occur. As an example, if two cathode electrodes are utilized in the circuit at the input load terminal 2, a voltage of 14.7 volts needs to be exceeded.

As mentioned earlier, the suppressor coil 3 and the shunt circuit 4 which are parallel to each other are connected in series with the circuit breaker 6 individually. An enclosure in which the suppressor coil 3 and the shunt circuit 4 are mounted in allows the user to connect the suppressor coil 3 and shunt circuit 4 in series with the circuit breaker 6 conveniently. The output source terminal 1 and the input load terminal 2 are positioned into the enclosure in order to maintain the series connection.

The following section describes the operation of the present invention. In the preferred embodiment of the present invention, the present invention prevents arc formation for an AC input load terminal or a DC input load terminal for the first ten microseconds. However, in another embodiment of the present invention, the arc formation can be controlled for different time periods. The normal line leakage currents are considered to be insignificant when compared to the normal current or the fault current. In order to generate a response from the suppressor coil 3 and the shunt circuit 4, the fault current needs to be fast and considerably large.

The preferred embodiment of the present invention is designed to be used to prevent aircraft wiring damage. Therefore, the values utilized in calculations are representative of the values seen on an aircraft circuit. In the following example, the transmission line 5 resistance is calculated for a circuit that operates at 28 volts (V) supply voltage and for a 10 amperes (A) maximum current. As mentioned before, the 28V can be from an output source terminal 1 which is AC or DC. Moreover, the transmission line 5 is considered to be 16 American wire gauge (AWG). In order to calculate the maximum length of the transmission line 5, the transmission line 5 resistance is initially calculated in the following manner.

Rₗᵢₙₑ—Line resistance
V_{supply}—Supply voltage
I_{DC}—Maximum current

### R_{breaker}—Nominal Resistance

V_{load}—Voltage across load

### R_{coil}—Coil Resistance

### R_{contact}—Contact Resistance

In this example, four contacts are used with each contact having a resistance of 4.5 mΩ.

Rₗᵢₙₑ=V_{supply}/I_{DC}−R_{breaker}−(V_{load}/I_{DC})−R_{coil}−(4*R_{contact})

Rₗᵢₙₑ=[(28/10)−0.14−(22/10)−0.00393−0.018]=0.564Ω

Therefore, the maximum length of the transmission line 5 at a resistance of 0.028 Ω/m is

(0.564/0.028)m=20.14 m

The following values for the suppressor coil 3 are utilized in the upcoming calculations. However, the values can change according to the circuit the present invention is being utilized in.

### L₂=16.0*10⁻⁶ H

R_{coil}=0.0048Ω [In this example (0.015*0.15) inch copper tape was used and the coil resistance needs to be minimized.]
C_{Pry}—Winding capacitance of the coil=7.5*10⁻¹² F

### L_{Damp}=1.0*10⁻⁶ H

R_{Damp}—Resistance of the shunt circuit=2.0 Ω.
R_{Loss}—The suppressor coil loss resistance=24830 Ω
The coil resistance can be represented as a resistor parallel to the suppressor coil 3.
The following values were used for the transmission line 5 for the preferred embodiment of the present invention. However, the values can differ in another embodiment of the present invention. As previously calculated, the length of the transmission line 5 is 20.14 m. However, for calculation purposes the length of the transmission line 5 is assumed to be 20 m.
L₁—Inductance of the transmission line=0.682*10⁻⁶ H
C₁—Capacitance of the transmission line=105.1*10⁻¹² F

### G₁=0

R₁—Conductivity of transmission line=0.028 Ω/m
The values utilized for the input load terminal 2 and the output source terminal 1 are as follows.
E_{gen}—Input load terminal voltage=28V
R_{gen}—Conservative input load terminal resistance=0
R_{CB}—Maximum circuit breaker resistance=0.014 Ω
I₀—The output source terminal current=10 A
R_{contact}—Contact resistance=(4*4.5) mΩ=0.018Ω
R_{load}—Resistance at the output source terminal=(28/10)−R_{gen}−R_{CB}−D*R₁−R_{contact}=2.203 Ω
C_{load}—Capacitance at the output source terminal=10⁻⁶ F
C_{load} is added to the circuit as an electromagnetic compatibility (EMC) filter. If a direct current power source is applied at the input load terminal 2 voltage, a value such as 2.7 Ω+3 μF can be used for C_{load}.
The distance required for an arc to occur is calculated in the following manner. In this preferred example, the distance required for an arc to occur between two copper electrodes is calculated. For two copper electrodes, the threshold voltage that needs to be overcome is 14.7V.
The following formula is used in calculating the arcing gap.

V_{arc}=A+M*s*I⁻ⁿ

V_{arc}—Initial breakdown voltage

### A—V_{cathode}

M—Arc vapor constant
T—Anode boiling temperature
n=2.62*T*10⁻⁴
I=arc current
In the preferred example:

### V_{arc}=100V/mil

### A=14.7V

M=257.6 for copper in air
T=2560K for copper
n=0.67 for copper
Using the above formula for an initial breakdown of 100V/mil, s=0.001*(22/100)=0.000022 inches. Therefore, if the two conductors are 0.000022 inches apart an electric arc is possible.
Furthermore, for the arc gap of 0.00022 inches if the arc current I=10 A,

V_{arc}=A+M*S*I⁻ⁿ

V_{arc}=14.7+256.7*0.00022*10⁻⁰⁶⁷

V_{arc}=14.7+0.012=14.712V

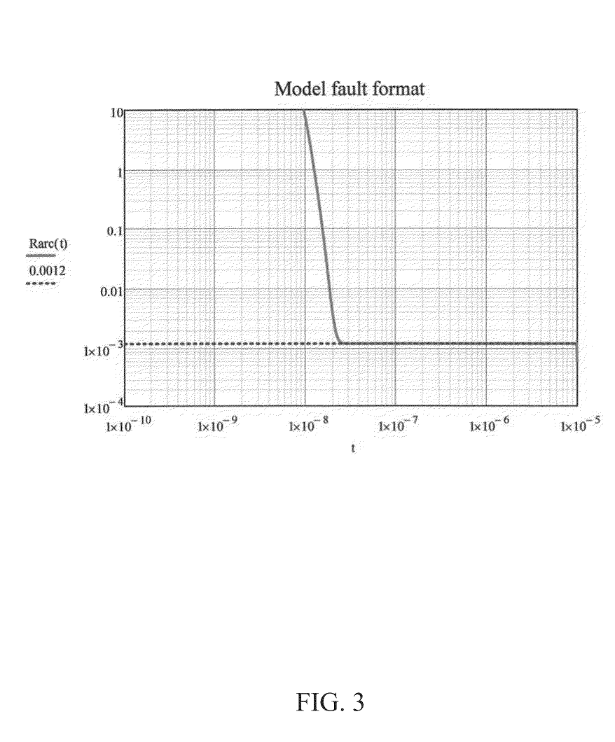

In the preferred example, the possible arc resistance is held for 10 μs followed by a short circuit. However, in different situations the arc resistance can hold for different time periods. The 10 μs allows for shorting time or arcing time, after a certain ionizing time. In an unprotected circuit, the worst fault may occur as the short circuit is released at high current. As seen in FIG. 3, a value of 1.2 mΩ lasts until 10⁻⁵ s represents the arcing period. The first portion, wherein the resistance drops from infinity to 1.2 mΩ represents the ionization time which occurs prior to an arc.

When the present invention is used in the circuit, the voltage across the transmission line 5 remains steady during the arcing period. Initially, the voltage across the suppressor coil 3 is dropped and the voltage that is across the transmission line 5 remains relatively steady such that there are no changing currents within the circuit. Therefore, G₁, which is the conductance of the transmission line 5 is zero.

The following equations are derived to describe the transmission line:

$$L 1 \cdot ( \frac{d}{d t} i ( x , t ) ) + R 1 \cdot i ( x , t ) = - ( \frac{d}{d x} e ( x , t ) )$$

$$C 1 \cdot ( \begin{matrix}d \\ d t\end{matrix} e ( x , t ) ) + G 1 \cdot e ( x , t ) = - ( \frac{d}{d x} i ( x , t ) )$$

By executing laplace operations the following equations were obtained.

$$( s \cdot L 1 + R 1 ) \cdot I ( x , s ) = - ( \frac{d}{d x} E ( x , s ) ) + L 1 \cdot i ( x , 0 )$$

$$( s \cdot C 1 + G 1 ) \cdot E ( x , s ) = - ( \frac{d}{d x} I ( x , s ) ) + C 1 \cdot e ( x , 0 )$$

The above formulas are manipulated to the following equations:

$$\frac{{d}^{2}}{d {x}^{2}} I ( x , s ) - ( s \cdot L 1 + R 1 ) \cdot ( s \cdot C 1 + G 1 ) \cdot I ( x , s ) = C 1 \cdot ( \frac{d}{d x} e ( x , 0 ) ) - L 1 \cdot ( s \cdot C 1 + G 1 ) \cdot i ( x , 0 )$$

$$\frac{{d}^{2}}{d {x}^{2}} E ( x , s ) - ( s \cdot L 1 + R 1 ) \cdot ( s \cdot C 1 + G 1 ) \cdot E ( x , s ) = L 1 \cdot ( \frac{d}{d x} i ( x , 0 ) ) - C 1 \cdot ( s \cdot L 1 + R 1 ) \cdot e ( x , 0 )$$

By applying Ohm's law to the circuit shown in FIG. 1, assuming that no current loss exists, the following formulas are obtained.

$$\begin{matrix}i ( x , 0 ) = i ( 0 , 0 ) & e ( x , 0 ) = i ( 0 , 0 ) \cdot [ R load + ( D - x ) \cdot R 1 ] \\ \frac{d}{d x} i ( x , 0 ) = 0 & \frac{d}{d x} e ( x , 0 ) = - i ( 0 , 0 ) \cdot R 1\end{matrix} \\ \frac{{d}^{2}}{d {x}^{2}} I ( x , s ) - {n ( s )}^{2} \cdot I ( x , s ) = C 1 \cdot ( - R 1 \cdot i ( 0 , 0 ) ) - L 1 \cdot s \cdot C 1 \cdot i ( 0 , 0 ) \\$$

Resultantly, a function independent of the distance x is obtained.

$$- C 1 \cdot i ( 0 , 0 ) \cdot ( R 1 + s \cdot L 1 ) = \frac{- i ( 0 , 0 ) \cdot {n ( s )}^{2}}{s}$$

Therefore, the differential equation with a particular solution is solved to find I(x,s).

$$I ( x , s ) = A 1 ( s ) \cdot exp ( x \cdot n ( s ) ) + B 1 ( s ) \cdot exp ( - x \cdot n ( s ) ) + \frac{i ( 0 , 0 )}{s}$$

In order to find A1 and B1 which are the transmission line 5 constants, t=0 and x=0 such that the differential equation is true at any given instant.

$$At time t = {0}^{-} , and x = 0$$

$$I ( 0 , s ) = A 1 ( s ) + B 1 ( s ) + \frac{i ( 0 , 0 )}{s}$$

$$B 1 ( s ) = - A 1 ( s )$$

$$I ( 0 , s ) = \frac{i ( 0 , 0 )}{s}$$

$$I ( x , s ) = 2 A 1 ( s ) \cdot sinh ( x \cdot n ( s ) ) + I ( 0 , s )$$

In order to find A1 the input load terminal 2 is taken into consideration the voltage on the transmission line 5 is calculated as E(x,s).

$$E ( x , s ) = \frac{1}{s \cdot C 1} \cdot ( C 1 \cdot e ( x , 0 ) - 2 \cdot n ( s ) \cdot A 1 ( s ) \cdot cosh ( x \cdot n ( s ) ) )$$

$$\begin{matrix}E ( x , s ) = \frac{\begin{matrix}s \cdot C 1 \cdot [ I ( 0 , s ) \cdot [ Rload + ( D - x ) \cdot R 1 ] ] - \\ 2 \cdot A 1 ( s ) \cdot n ( s ) \cdot cosh ( x \cdot n ( s ) )\end{matrix}}{C 1 \cdot s}\end{matrix}$$

$$E ( 0 , s ) = \frac{C 1 \cdot [ I ( 0 , s ) \cdot ( Rload + D \cdot R 1 ) ] - 2 \cdot A 1 ( s ) \cdot n ( s )}{C 1 \cdot s} \\ E ( D , s ) = Rload \cdot I ( 0 , s ) - \frac{2 \cdot A 1 ( s ) \cdot n ( s ) \cdot cosh ( D \cdot n ( s ) )}{s \cdot C 1} = I ( D , s ) \cdot Zload ( s ) \\ \begin{matrix}E ( D , s ) \\ I ( D , s ) \cdot Zload ( s )\end{matrix} = 1$$

$$A 1 ( s ) = \frac{Rload - Zload ( s )}{2 \cdot Zload ( s ) \cdot sinh ( D \cdot n ( s ) ) + \frac{2 \cdot n ( s ) \cdot cosh ( D \cdot n ( s ) )}{C 1 \cdot s}} \cdot I ( 0 , s )$$

The supply current in the circuit={Initial voltage at t=0⁻}/{Circuit impedance at t=0⁺}

$$I ( s ) = \frac{\frac{Egen}{s} + s \cdot I ( 0 , s ) \cdot ( Lcoil + D \cdot L 1 )}{Rgen + Rcb + Zcoil ( s ) + Zin ( s )}$$

As a result, the input impedance can be found at t=0⁺

$$Zin ( s ) = \frac{E ( 0 , s )}{I ( 0 , s )} = \frac{\frac{s \cdot C 1 \cdot [ I ( 0 , s ) \cdot ( Rload + D \cdot R 1 ) ] - 2 \cdot A 1 ( s ) \cdot n ( s )}{C 1 \cdot s}}{I ( 0 , s )}$$

By substituting the value for the previously calculated A1 value the value for Zin(s) is obtained.

$$Zin ( s ) = Rload + D \cdot R 1 + \frac{( Zload ( s ) - Rload )}{cosh ( D \cdot n ( s ) ) + \frac{C 1 \cdot s}{n ( s )} \cdot Zload ( s ) \cdot sinh ( D \cdot n ( s ) )}$$

The load impedance is calculated in the following manner. The input load terminal 2 is in parallel with the arc impedance. The contact resistance is also utilized when calculating the load impedance.

$$Zload ( s ) := {( \frac{1}{Rload} + \frac{1}{Rarc ( s )} + s \cdot Cload )}^{- 1} + \frac{Rcontact}{2}$$

$$n ( s ) = \sqrt{s \cdot C 1 \cdot ( R 1 + s \cdot L 1 )}$$

The following section describes the situation when the present invention is not included in the circuit. More specifically, a normal short circuit is described. Since the suppressor coil 3 and the shunt circuit 4 is not present, the short circuit current I_{SC} is given by the following formula.

$$Isc ( s ) = \frac{\frac{Egen}{s} + Io \cdot ( D \cdot L 1 )}{Rcb + Zin ( s )}$$

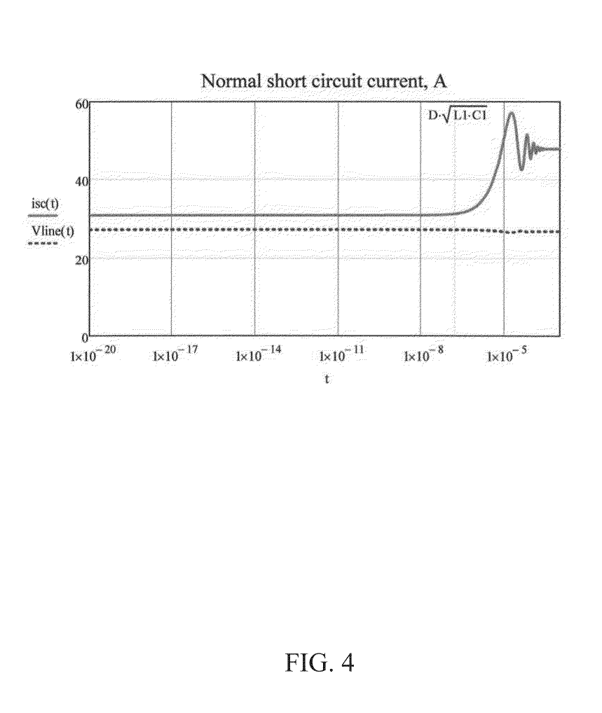

As illustrated in FIG. 4, the standing waves in the transmission line 5 results in a spike and a ringing portion. By constructing partial fraction expansions from the graph illustrated in FIG. 4, the non-existent terms, commonly known as the non-causal terms are eliminated. More specifically, the terms leading to infinite energy are ignored in the calculations.

In contrast to the above section, wherein the normal short circuit was described, the following section describes the circuit when the suppressor coil 3 and the shunt circuit 4 are integrated into the circuit. As discussed earlier, the present invention helps shape the net coil current. The suppressor coil 3 impedance is defined as a parallel combination of the coil resistance, loss resistance, the shunt circuit 4, and the primary capacitance. As a result, the following equation is obtained for the coil impedance.

$$Zcoil ( s ) = {( \frac{1}{Rcoil + s \cdot L 2} + \frac{1}{Rloss} + \frac{1}{Rdamp + s \cdot Ldamp} + s \cdot Cpry )}^{- 1}$$

Next, an equation for the current through the circuit when the suppressor coil 3 and the shunt circuit 4 integrated is calculated.

$$I ( s ) = \frac{\frac{Egen}{s} + Io \cdot ( L 2 + D \cdot L 1 )}{Rcb + Zcoil ( s ) + \frac{Rcontact}{2} + Zin ( s )}$$

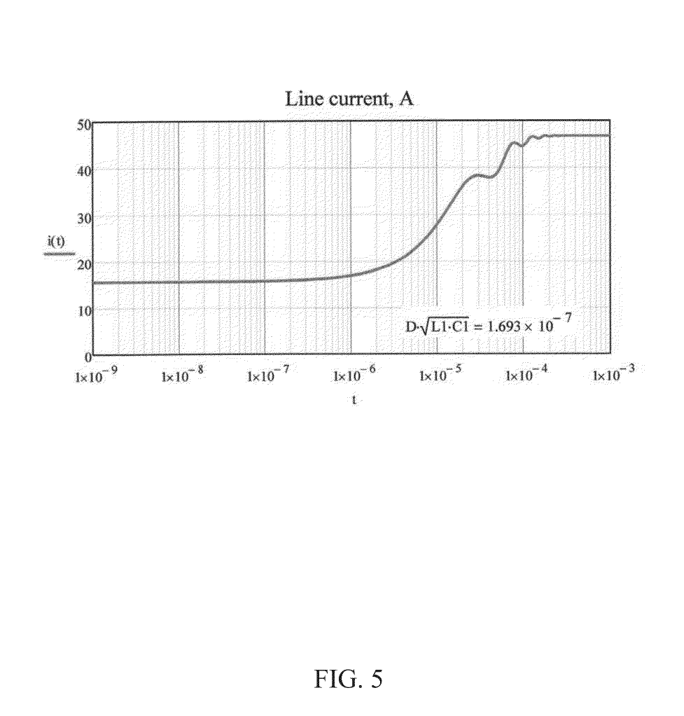

FIG. 5 illustrates the line current when the suppressor coil 3 and the shunt circuit 4 are integrated into the circuit. When compared to FIG. 4, the ringing in FIG. 5 has been eliminated. Most importantly the current has been decreased. As seen in FIG. 4, the short circuit current at 10⁻⁵ s is approximately 28 A. However, as seen in FIG. 5 the current through the coil has decreased to approximately 18 A. Therefore, it is clearly seen that the components of the shunt circuit 4 significantly reduce the current through the coil. In order to calculate the coil current, the following equation was used.

$$Icoil ( s ) = \frac{I ( s )}{1 + ( Rcoil + s \cdot L 2 ) \cdot ( \frac{1}{Rloss} + \frac{1}{Rdamp + s \cdot Ldamp} + s \cdot Cpry )}$$

In the preferred embodiment of the present invention, the current is controlled for the first 10⁻⁵ s. However, different control times can be used in other embodiments of the present invention.

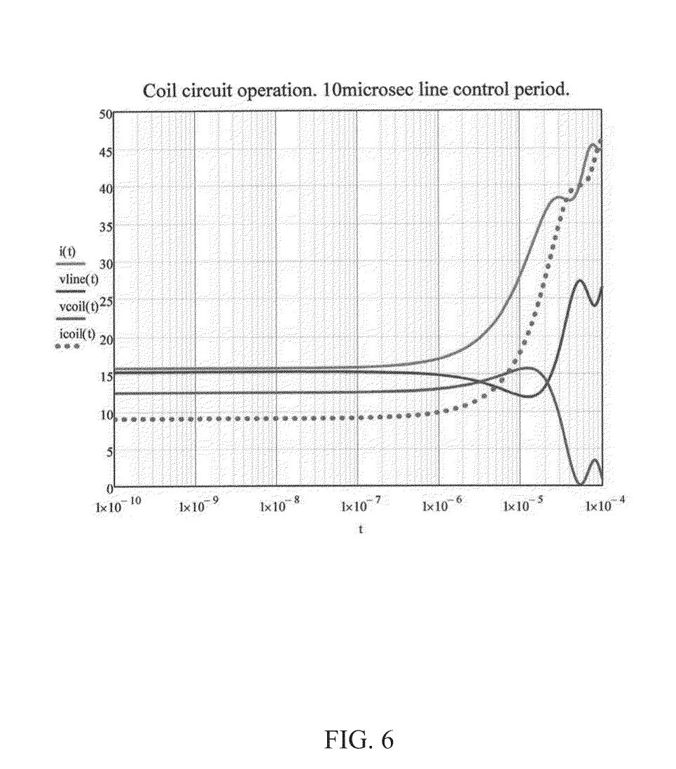

FIG. 6 illustrates the operation of the suppressor coil 3 and the shunt circuit 4. In this graph, the dotted line on the graph, icoil (t), represents the final current that passes through the suppressor coil 3. The solid red line represents the line current i(t). vcoil(t) represents the voltage across the suppressor coil 3. The blue line, vline (t) represents the voltage coming out of the suppressor coil 3 and is presented to the transmission line 5. More specifically, vline(t) represents the voltage supplied to the input load terminal 2. In FIG. 6, the differential of icoil(t), which is dicoil(t)/dt, is approximately 10 times smaller than the line current i(t).

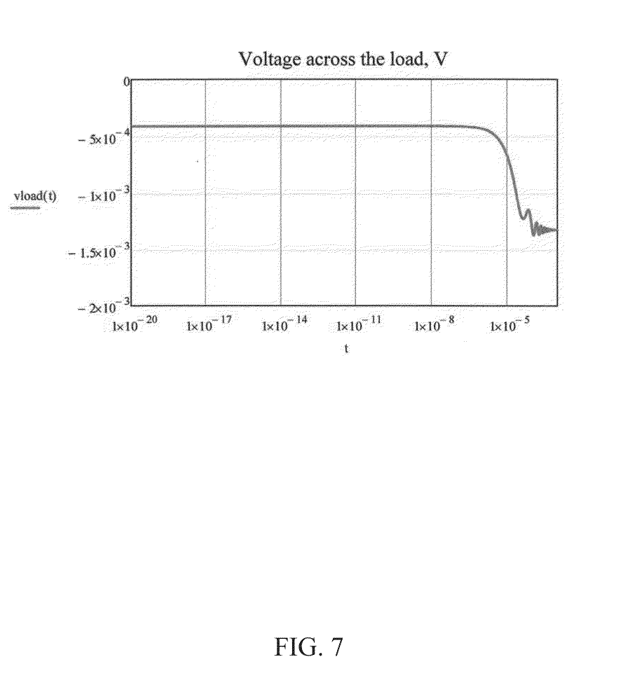

FIG. 7 is an illustration of the voltage across the input load terminal 2. The voltage across the input load terminal 2 is given by the following formula in terms of the current, the input load terminal 2 resistance, and the contact resistance.

$$Vload ( s ) = I ( s ) \cdot ( Zload ( s ) - \frac{Rcontact}{2} )$$

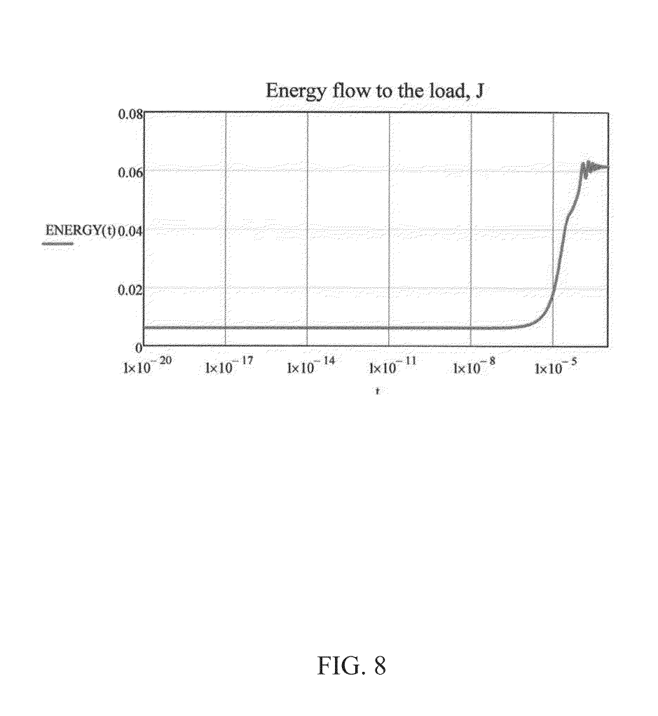

As seen in the graph, the voltage is constant up to a time period of approximately 10⁻⁵ s. Therefore, no arcing occurs during this time period.
The energy at the input load terminal 2 is calculated using the voltage at the input load terminal 2 and the current through the input load terminal 2. In this instance, the energy is approximately 6 mJ. Therefore, the energy at the input load terminal 2 is lower than an energy level required to cause hazardous situations. FIG. 8 is an illustration of the energy flow to the input load terminal 2, wherein the voltage is applied across the input load terminal 2 constant.

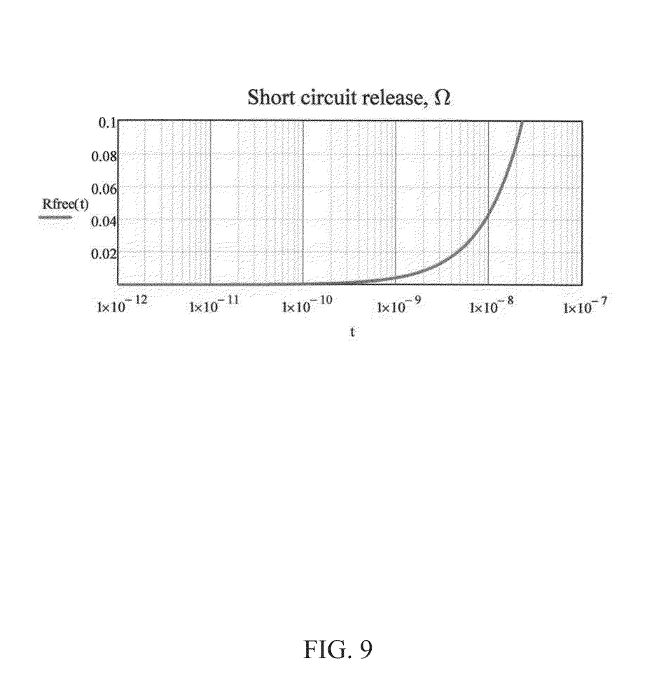

FIG. 9 is an illustration of the current through the input load terminal 2 when the fault stays on and the circuit breaker 6 has not been activated. In this instance, all the stored energy in the transmission line 5 results in an arc. Therefore, the release current that results in the arc, Iᵣₑₗ, is calculated with the following formula.

$$Irel ( s ) = \frac{\frac{Egen}{s} + Ishort \cdot ( Lsat + D \cdot L 1 )}{Rcb + Zcoil ( s ) + \frac{Rcontact}{2} + Zin ( s )}$$

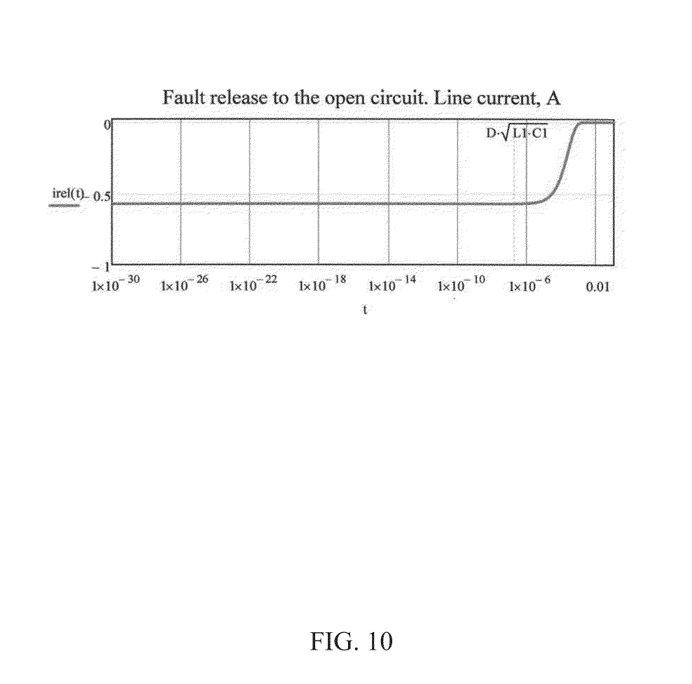

The variation of Iᵣₑₗ is represented in FIG. 10.

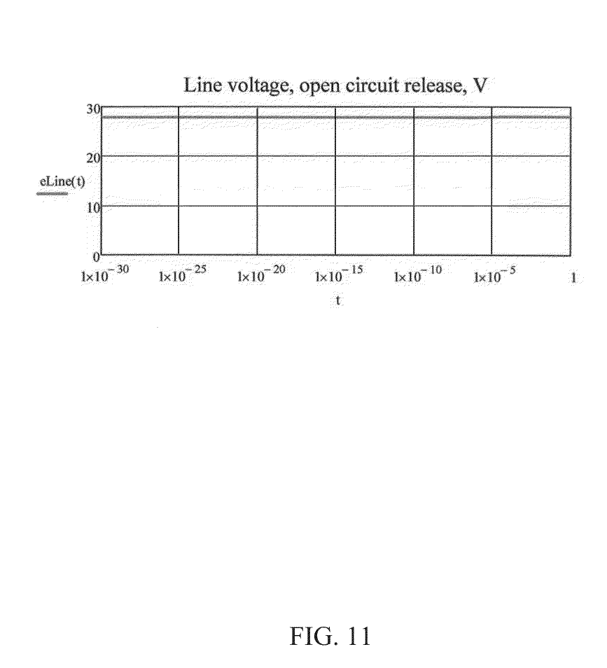

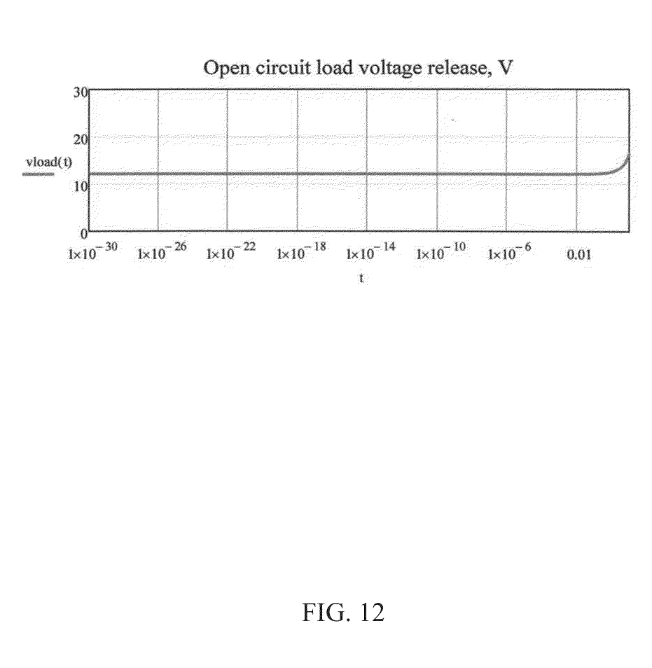

FIG. 11 and FIG. 12 illustrate the transmission line 5 voltage and the input load terminal 2 voltage at open circuit respectively. As seen in FIG. 11, the voltage of approximately 28V is held down to a value of approximately 12V in FIG. 12.

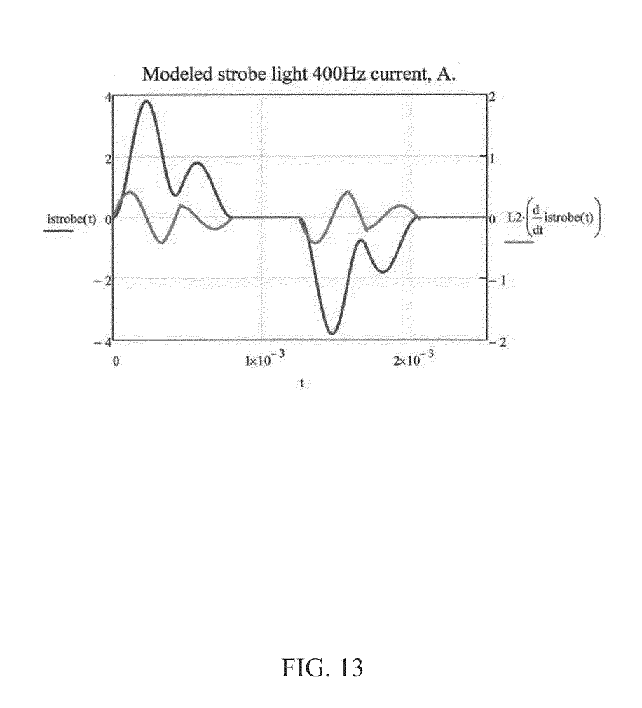

FIG. 13 is a representation of the current through a strobe light and the rate of change through the suppressor coil 3 when the present invention was used along with a 400 Hz strobe light. As seen in FIG. 13, the rate of change is constant and the suppressor coil 3 inductance is small such that there is minimum response to the rate of change.

Although the invention has been explained in relation to its preferred embodiment, it is to be understood that many other possible modifications and variations can be made without departing from the spirit and scope of the invention as hereinafter claimed.

What is claimed is:

1. A device for arc suppression using an alternating current power source or a direct current power source comprises:
an output source terminal;
an input load terminal;
a suppressor coil;
a shunt circuit;
the suppressor coil being electrically connected in series between the output source terminal and the input load terminal;
the shunt circuit being electrically connected in series between the output source terminal and the input load terminal; and
the suppressor coil and the shunt circuit being electrically connected in parallel to each other.

2. The device for arc suppression using an alternating current power source or a direct current power source as claimed in claim 1 comprises:
an at least one transmission line;
the suppressor coil being electrically connected in series with the input load terminal through the transmission line;
the shunt circuit being electrically connected in series with the input load terminal through the transmission line;

3. The device for arc suppression using an alternating current power source or a direct current power source as claimed in claim 2, wherein a portion of the transmission line is a portion of an aircraft body.

4. The device for arc suppression using an alternating current power source or a direct current power source as claimed in claim 1, wherein the shunt circuit comprises at least one resistor, at least one inductor, and at least one capacitor.

5. The device for arc suppression as claimed in claim 1, wherein the output source terminal is for an alternating current power source.

6. The device for arc suppression as claimed in claim 1, wherein the output source terminal is for a direct current power source.

7. The device for arc suppression using an alternating current power source or a direct current power source as claimed in claim 1 comprises:
an enclosure;
the suppressor coil and the shunt circuit being mounted within the enclosure;
the output source terminal being positioned into the enclosure; and
the input load terminal being positioned into the enclosure.

8. The device for arc suppression as claimed in claim 1, wherein the suppressor coil is a permeable coil.

9. The device for arc suppression as claimed in claim 1, wherein the suppressor coil is an air core coil.

10. The device for arc suppression as claimed in claim 1, wherein the suppressor coil is configured to generate electrical inductance and to be electrically resistive.

11. A device for arc suppression using an alternating current power source or a direct current power source comprises:
an output source terminal;
an input load terminal;
a suppressor coil;
a shunt circuit;
the suppressor coil being electrically connected in series between the output source terminal and the input load terminal;
the shunt circuit being electrically connected in series between the output source terminal and the input load terminal;
the suppressor coil and the shunt circuit being electrically connected in parallel to each other;
an at least one transmission line;
the suppressor coil being electrically connected in series with the input load terminal through the transmission line; and
the shunt circuit being electrically connected in series with the input load terminal through the transmission line.

12. The device for arc suppression using an alternating current power source or a direct current power source as claimed in claim 11, wherein a portion of the transmission line is a portion of an aircraft body.

13. The device for arc suppression using an alternating current power source or a direct current power source as claimed in claim 11, wherein the shunt circuit comprises at least one resistor, at least one inductor, and at least one capacitor.

14. The device for arc suppression as claimed in claim 11, wherein the output source terminal is for an alternating current power source.

15. The device for arc suppression as claimed in claim 11, wherein the output source terminal is for a direct current power source.

16. The device for arc suppression using an alternating current power source or a direct current power source as claimed in claim 11 comprises:
an enclosure;
the suppressor coil and the shunt circuit being mounted within the enclosure;
the output source terminal being positioned into the enclosure; and
the input load terminal being positioned into the enclosure.

17. The device for arc suppression as claimed in claim 11, wherein the suppressor coil is a permeable coil.

18. The device for arc suppression as claimed in claim 11, wherein the suppressor coil is an air core coil.

19. The device for arc suppression as claimed in claim 11, wherein the suppressor coil is configured to generate electrical inductance and to be electrically resistive.
